(19) United States
(12) Patent Application Publication
(10) Pub. No.: US 2002/0083803 A1
(43) Pub. Date: Jul. 4, 2002

(54) Groove slip joint plier

(75) Inventor: Qiu Jian Ping, Hiangzhou (CN)

Correspondence Address: JOSEPH J. PREVITO, 1077 NORTHERN BOULEVARD, ROSLYN, NY, 11576-1696, US

(73) Assignee: Great Neck Saw Manufacturers, Inc.

(21) Appl. No.: 09/751,072

(22) Filed: Jan. 2, 2001

(51) Int. Cl. B25B 7/04

(52) U.S. Cl. 81/394

(57) ABSTRACT

A plier having a first handle member and a second handle member. The first handle member has a first hand grip portion, a first intermediate potion and a first jaw portion. The second handle member has a second hand grip portion, a second intermediate portion and a second jaw portion. The second jaw portion is movable relative to the first jaw portion and the second hand grip portion is movable relative to the first hand grip portion. The second intermediate portion is pivotally mounted on the first handle member. The second intermediate portion is connected to the second jaw portion so that movement of the second hand grip portion will move the second jaw portion relative to the first jaw portion.

### BACKGROUND

The present invention relates to pliers and more particularly to an improved groove slip joint plier.

Groove slip joint pliers are adapted to move a pair of jaws toward or away from each other in a path which is generally at right angles to the jaw teeth so that the jaw teeth remain parallel to each other as they move toward and away from each other. This permits the jaws to firmly and positively grip articles between them.

Groove slip joint pliers in the past use complicated mechanisms in order to permit the jaws to be moved toward and away from each other. Such pliers are difficult to handle and are expensive to manufacture.

### OBJECTS

The present invention avoids these problems and has for one of its objects the provision of an improved groove slip joint plier which is simple to use.

Another object of the present invention is the provision of an improved groove slip joint plier which is simple to assemble.

Another object of the present invention is the provision of an improved groove slip joint plier which is inexpensive to manufacture.

Other and further objects of the invention will be obvious upon an understanding of the illustrative embodiment about to be described, or will be indicated in the appended claims and various advantages not referred to herein will occur to one skilled in the art upon employment of the invention in practice.

### BRIEF DESCRIPTION OF THE DRAWING

A preferred embodiment of the invention has been chosen for purposes of illustration and description and is shown in the accompanying drawings forming a part of the specification, wherein:

### DRAWINGS

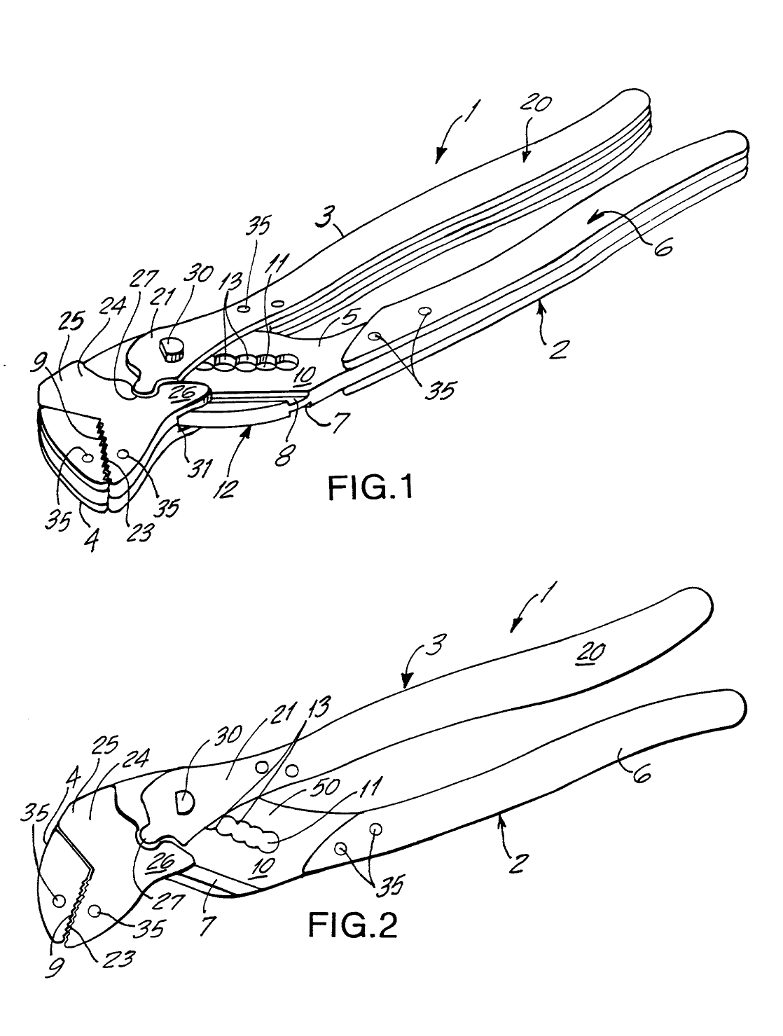

FIG. 1 is a perspective view of the tool of the present invention.

FIG. 2 is a plan view of the tool with its jaws closed.

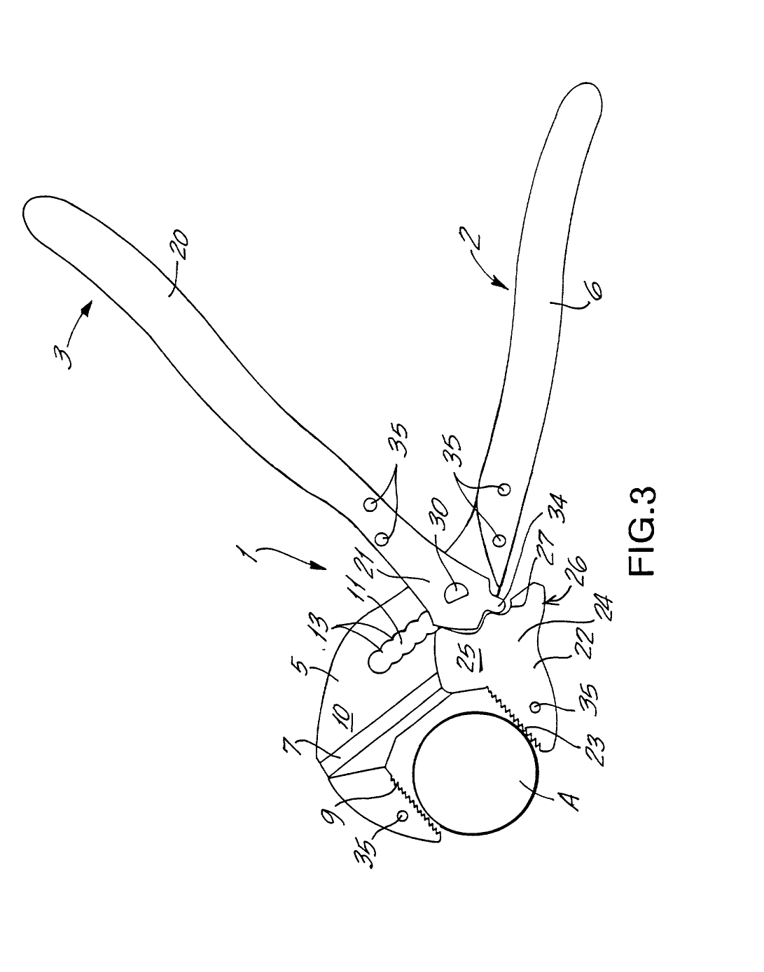

FIG. 3 is a plan view of the tool with its jaws open.

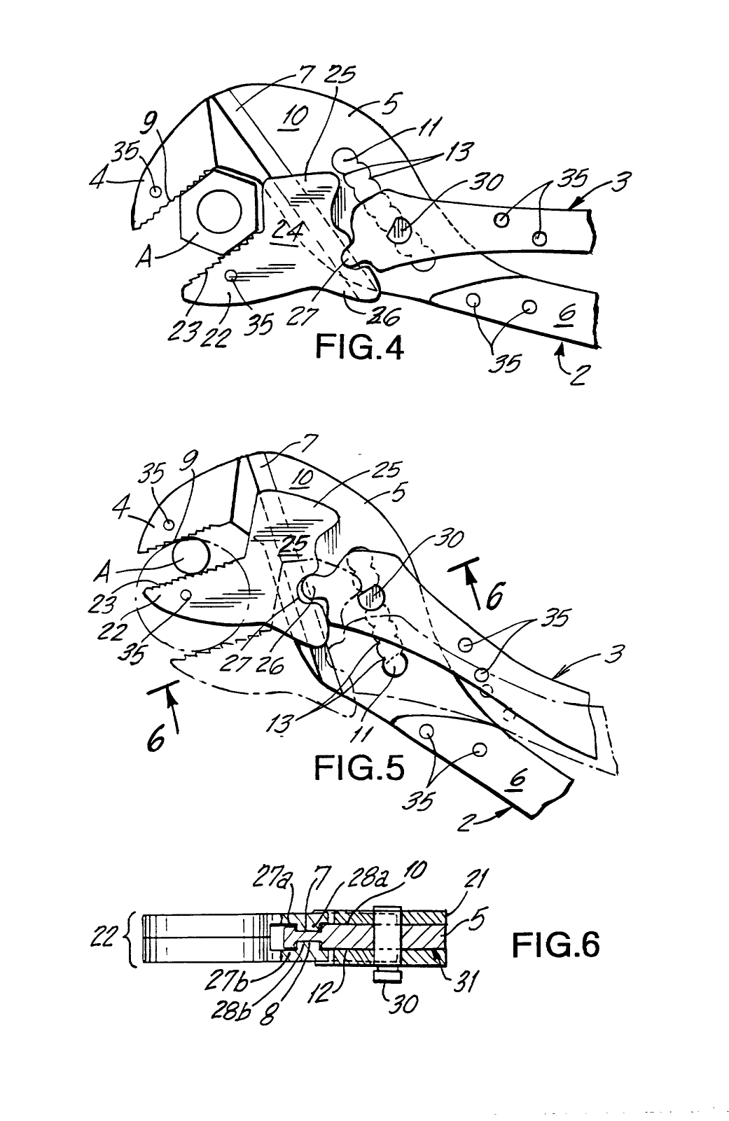

FIG. 4 is a plan view of the tool jaws showing the position of the parts with the tool in one position.

FIG. 5 is a plan view of the tool jaws sharing the position of the parts with the tool in another position.

FIG. 6 is a perspective view taken along line 6-6 of FIG. 5.

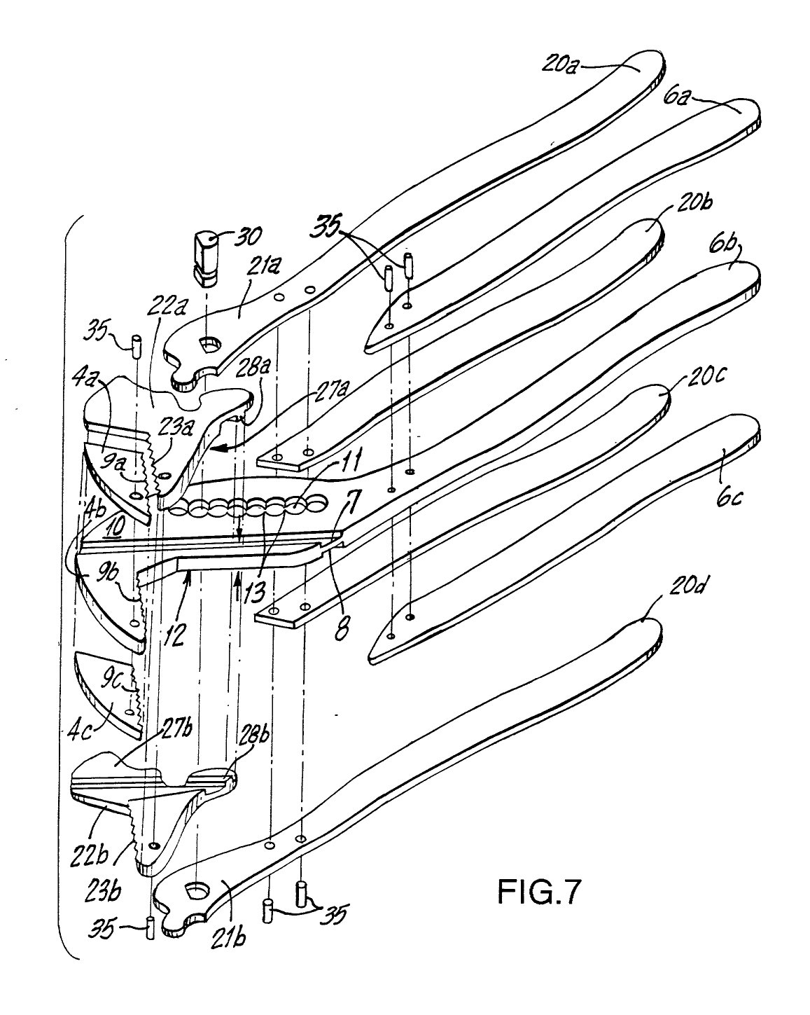

FIG. 7 is an exploded perspective view showing the various parts of the present invention.

### DESCRIPTION

Referring to the drawings, the slip joint plier 1 of the present invention comprises a first handle member 2 and a second handle member 3. The first handle member 2 is preferably made in one piece and comprising a stationary jaw portion 4, an intermediate portion 5, and a hand grip portion 6. The jaw portion 4 has an array of teeth 9 extending inwardly and preferably in a straight line. The intermediate portion 5 is provided with a pair of opposed elongated grooves 7 and 8 extending inwardly from each face 10 and 12 respectively, of the intermediate portion 5. The intermediate portion 5 is also provided with a slot 11 substantially parallel to the grooves 7 and 8 which extends through the intermediate portion 5 from one face 9 to the other face 10. The slot 11 a plurality of opposed indentations 13 which will be discussed in greater detail hereinbelow.

The second handle member 3 comprises a moveable hand grip portion 20, an intermediate portion 21 integral with the hand grip portion 20 and a moveable jaw portion 22. The moveable jaw portion 22 has a array of teeth 23 which face the array of teeth 9 in the stationary jaw portion 4 and are substantially parallel thereto. The moveable jaw portion 22 has a base 24 extending therefrom. The base 24 has an inner section 25, an outer section 26 and a notch 27 interposed between the inner and outer sections 25-26. The base 24 of the moveable jaw portion 22 is preferably comprised of opposed inner faces 27a and 27b (FIG. 7). The inner faces 27a and 27b of the base has slide blocks 28a and 28b extending inwardly therefrom. The slide blocks 28a and 28b extend inwardly into the opposed grooves 7-8 in the intermediate portion 5 of the first handle member 2. The intermediate portion 21 of the second handle member 3 has a lug 34 extending therefrom and adapted to be inserted in the notch 27 in the base 24 of the moveable jaw portion 22. The intermediate portion 21 of the second handle member 2 has a pivot pin 30 mounted therein which extends into and moves along the slot 11 in the intermediate portion 5 in the first handle member 2. When the movable handle 3 is moved in one direction or the other it will pivot around pin 30 and will move its lug 34 in one direction or the other thereby allowing the movable jaw 22 to slide toward and away from the stationary jaw through the between leg 34 and notch 27. A space 31 (FIG. 2) is formed in the intermediate portion 21 of the second handle member 3 in order to receive the intermediate portion 5 of the first handle member 2.

When the jaws portions 4-22 are to be moved together or apart, moveable hand grip 20 is moved toward or away from stationary hand grip 6 around pivot pin 30 and because of the connection between lug 34 and notch 27, the moveable jaw portion 22 will slide relative to the permanent jaw portion 4 with the slide blocks 28a and 28b sliding in grooves 7-8 in the intermediate portion 5 of the first handle member 2. The pivot pin 30 will slide within and along the slot 11 and when the jaw portions 4-22 tighten around an article A, the pivot pin 30 will enter one of the indentations 13 in the slot 11. When the article A is to be released, the moveable hand grip 20 is moved away from the stationary hand grip 6 so that the pivot pin 30 now slides in the slot 11 in the opposite direction and the slide blocks 28a and 28b will slide in the grooves 7-8 in the opposite direction to move the jaws 4-22 away from each other to release the article A. It will be seen that in both operations the teeth arrays 9-23 remain and move in parallel relationship to each other.

In a preferred embodiment of the invention as shown in FIG. 7, the tool of the present invention is formed by a plurality of laminations which are held together in any well known manner, as by the pins 35. However, it will be understood that use of laminations is not essential to the invention since the various elements can be made in single pieces. The hand grip portion 6 of the first handle member 2 is formed by a plurality of laminations 6a6b, and 6c. The jaw portion 4 of the first handle member 2 is also formed by a plurality of laminations 4a, 4b, and 4c embodying teeth arrays 9a, 9b, and 9c. The intermediate portion 5 of the first handle member 2 is not laminated but is a single piece. The hand grip portion 20 of the second handle member 3 is formed by a plurality of laminations 2a, 2b, and 2c. The intermediate portion 21 of the second handle member 3 is formed by a pair of space laminations 21a, and 21b, which form the space 31 within which the intermediate portion 5 of the first handle member 3 will lie and move. The jaw portion 22 of the second handle member 3 is formed by a pair of laminations 22a, and 22b embodying teeth array 23a and 23b.

It will thus be seen that th present invention provides an improved groove slip joint plier which is simple to use, which is simple to assemble and which is inexpensive to manufacture.

As many and varied modifications of the subject matter of this invention will become apparent to those skilled in the art from the detailed description given hereinabove, it will be understood that the present invention is limited only as provided in the claims appended hereto.

The embodiments of the invention in which an exclusive property or privilege is claimed are defined as follows:

1. A plier comprising a first handle member and a second handle member, the first handle member comprising a first hand grip portion, a first intermediate portion and a first jaw portion, the second handle member comprising a second hand grip portion, a second intermediate portion and a second jaw portion, the second jaw portion being movable relative to the first jaw portion, the second hand grip portion being movable relative to the first hand grip portion, the second intermediate portion being pivotally mounted on the first handle member, means operatively connecting the second intermediate portion to the the second jaw portion whereby movement of the second hand grip portion will move the second jaw portion relative to the first jaw portion.

2. A plier as set forth in claim 1 wherein slide means are provided along which said second jaw portion moves relative to the first jaw portion.

3. A plier as set forth in claim 2, wherein said slide means comprises a slide block on said second jaw portion and a slide groove in said first intermediate portion.

4. A plier as set forth in claim 3 wherein a pivot pin means are provided to permit the second hand grip portion to pivot relative to the first hand grip portion.

5. A plier as set forth in claim 4 wherein said pivot means comprises a pivot pin on said second intermediate portion

6. A plier as set forth in claim 5 wherein a slot is provided in the first intermediate portion within which said pivot pin extends and along which it moves.

7. A plier as set forth in claim 6 wherein said slot is parallel to the slide groove.

8. A plier as set forth in claim 7 wherein the second jaw portion first attachment means and wherein the second intermediate portion has second attachment means, said first and second attachment means cooperating with each other to operatively connect the second intermediate portion to the second jaw portion.

9. A plier as set forth in claim 8 wherein said second attachment means comprises a lug in the second intermediate portion and said first attachment means comprises a notch in the second jaw portion, and wherein said lug is adapted to be mounted within said notch.

10. A plier as set forth in claim 9 wherein said slot has a plurality of indentations therein into which said pivot pin is adapted to enter when the second jaw portion reaches a predetermined position relative to the first jaw portion.

11. A plier as set forth in claim 10 whereby said first and second jaw portions each have an array of teeth parallel to each other.

12. A plier as set forth claim 11 wherein the second intermediate portion has a space to receive the first intermediate portion.

13. A plier as set forth in claim 12 wherein said first and second jaw portions and said first and second hand grip portions are comprised of laminations connected together.

14. A plier as set forth in claim 13 wherein the second intermediate portion has spaced of laminations to form the said space.
